(19) United States
(12) Patent Application Publication
(10) Pub. No.: US 2021/0136498 A1
(43) Pub. Date: May 6, 2021

(54) Speaker Diaphragm and Method for Manufacturing Speaker Diaphragm

(71) Applicant: Yamaha Corporation, Hamamatsu-shi (JP)

(72) Inventors: Hiroshi NAKASHIMA, Hamamatsu-shi (JP); Eiji ABE, Iwata-shi (JP); Tsunenori SANO, Hamamatsu-shi (JP); Kunio HIYAMA, Hamamatsu-shi (JP)

(21) Appl. No.: 17/148,098

(22) Filed: Jan. 13, 2021

Related U.S. Application Data
(63) Continuation of application No. PCT/JP2019/029312, filed on Jul. 25, 2019.

(30) Foreign Application Priority Data
Jul. 27, 2018 (JP) 2018-141804
Nov. 16, 2018 (JP) 2018-215321

(51) Int. Cl. H04R 7/12; H04R 31/00

(52) U.S. Cl. CPC H04R 7/12; H04R 31/003

(57) ABSTRACT

A speaker diaphragm includes a substrate. The substrate includes a resin matrix and fibers. The resin matrix contains a thermoplastic resin as a main component. The fibers are dispersed in the resin matrix. The fibers are polyparaphenylenebenzobisoxazol fibers. An average length of the fibers is 0.5 mm or more and 3.0 mm or less.

### TECHNICAL FIELD

The embodiments of the present invention relate to a speaker diaphragm and a method for producing a speaker diaphragm.

### BACKGROUND

It is desired that a speaker diaphragm have high rigidity to generate sound efficiently. In addition, the speaker diaphragm is required to have excellent environment resistance, and is desired to have high water resistance.

From such a viewpoint, a speaker diaphragm made of a synthetic resin has been proposed in place of a speaker diaphragm made of a papermaking product of a wood pulp. As such a speaker diaphragm, one obtained by impregnating long fibers each having a length of 3 mm to 50 mm with a resin has been proposed.

### SUMMARY

### Technical Problems

However, if fibers each having a large length are impregnated with a resin like the speaker diaphragm described in the above publication, it is difficult to disperse the fibers uniformly in the resin. In particular, in this speaker diaphragm, the larger the fiber content, the more likely the fibers are to be unevenly distributed in the resin. Therefore, it is difficult to sufficiently increase the rigidity of the speaker diaphragm over the entire region.

The embodiments of the present invention have been made under such circumstances, and an object of the embodiments of the present invention is to provide a speaker diaphragm whose rigidity is uniformly increased over the entire region and a method for producing the speaker diaphragm.

### Solutions To Problems

One aspect of the present invention made to solve the above problems is a speaker diaphragm including a substrate having a resin matrix containing a thermoplastic resin as a main component and fibers dispersed in the resin matrix, in which the fibers are polyparaphenylenebenzobisoxazol fibers, and an average length of the fibers is 0.5 mm or more and 3.0 mm or less.

Further, another aspect of the present invention made to solve the above problems is a method for producing a speaker diaphragm, including the steps of: extruding a resin composition containing a thermoplastic resin and fibers into a rod shape; cutting the rod shape into pellets; and injection-molding the pellets obtained in the cutting step, in which the fibers are polyparaphenylenebenzobisoxazol fibers, and an average length of the fibers after the cutting step is 0.5 mm or more and 3.0 mm or less.

### BRIEF DESCRIPTION OF THE DRAWINGS

FIG. 1 is a schematic front view of a speaker diaphragm according to an embodiment of the present invention.

FIG. 2 is a cross-sectional view taken along a line A-A of the speaker diaphragm of FIG. 1.

FIG. 3 is a schematic diagram illustrating a dispersed state of fibers in a resin matrix of the speaker diaphragm of FIG. 1.

FIG. 4 is a flowchart illustrating a method for producing a speaker diaphragm according to an embodiment of the present invention.

### DETAILED DESCRIPTION OF EMBODIMENTS

One aspect of the present invention is a speaker diaphragm including a substrate having a resin matrix containing a thermoplastic resin as a main component and fibers dispersed in the resin matrix, in which the fibers are polyparaphenylenebenzobisoxazol fibers, and an average length of the fibers is 0.5 mm or more and 3.0 mm or less.

In the speaker diaphragm according to one aspect of the present invention, the fibers dispersed in the resin matrix are polyparaphenylenebenzobisoxazol fibers, and thus the fibers easily increase rigidity sufficiently. Particularly, in the speaker diaphragm, since the average length of the polyparaphenylenebenzobisoxazol fibers is within the above range, the fibers can be uniformly dispersed in the resin matrix. As a result, the speaker diaphragm can uniformly increase the rigidity over the entire region.

The speaker diaphragm preferably has a cone shape.

In the speaker diaphragm, the substrate preferably has a pair of skin layers that form surface layers on the front surface side and the back surface side thereof, and a core layer formed between the pair of skin layers.

The content of the fibers in the substrate is preferably 3% by mass or more and 30% by mass or less.

In the speaker diaphragm, preferably, the resin matrix and the fibers are not bonded at least partially.

In the speaker diaphragm, the thermoplastic resin is preferably polypropylene.

Further, another aspect of the present invention is a method for producing a speaker diaphragm, including the steps of: extruding a resin composition containing a thermoplastic resin and fibers into a rod shape; cutting an extruded body extruded in the extrusion step into pellets; and injection-molding the pellets obtained in the cutting step, in which the fibers are polyparaphenylenebenzobisoxazol fibers, and an average length of the fibers after the cutting step is 0.5 mm or more and 3.0 mm or less.

A method for producing a speaker diaphragm according to another aspect of the present invention includes injection-molding a speaker diaphragm using pellets obtained by cutting a rod-shaped extruded body containing a thermoplastic resin and polyparaphenylenebenzobisoxazol fibers, and thus, it is possible to produce a speaker diaphragm in which the polyparaphenylenebenzobisoxazol fibers are dispersed in the thermoplastic resin sufficiently and uniformly. Particularly, in the method for producing a speaker diaphragm, the average length of the polyparaphenylenebenzobisoxazol fibers in the pellet is within the range described above, and thus, in the obtained speaker diaphragm, the fibers can be uniformly dispersed without being entangled with each other in the thermoplastic resin. The lump of fibers are generated by the entanglement of the fibers. Therefore, when injection molding is performed, the flow path of the material may be clogged by the lumps of fibers. Moreover, since the lump of fibers is not uniformly dispersed in the thermoplastic resin, the rigidity of the speaker diaphragm cannot be increased. On the other hand, by connecting fibers to be spun, it is possible to uniformly disperse the fibers in the thermoplastic resin, so that the rigidity of the speaker diaphragm can be increased. That is, according to the method disclosed in the present specification, it is possible to manufacture a speaker diaphragm which rididity is uniformly increased over the entire region of the diaphragm.

In the present invention, the “main component” refers to a component having the highest content in terms of mass, for example, a content of 50% by mass or more, preferably 70% by mass or more, more preferably 90% by mass or more. The “average length of fibers” refers to an average value of lengths of arbitrary 10 fibers. The “front surface side” means a sound emitting direction side, and the “back surface side” means the opposite side. The “surface layer” refers to a region having a depth of 50 μm or less from the front surface and the back surface of a target object or layer.

Hereinafter, embodiments of the present invention will be described in detail with reference to the drawings as appropriate.

### [Speaker Diaphragm]

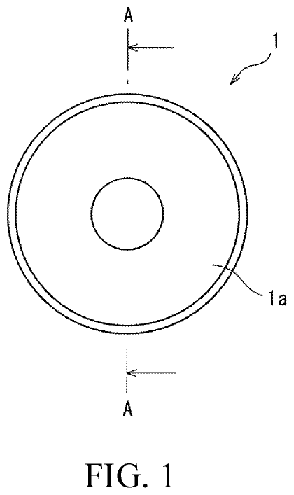

A speaker diaphragm 1 of FIGS. 1 to 3 includes a substrate 1a having a resin matrix 2 containing a thermoplastic resin as a main component and fibers 3 dispersed in the resin matrix 2. The speaker diaphragm 1 is a single body of the substrate 1a.

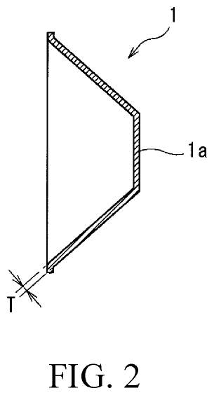

The speaker diaphragm 1 can be configured in a shape tailored to a speaker to be used, and has a cone shape in FIGS. 1 and 2. That is, the substrate 1a has a cone shape. When the speaker diaphragm 1 has a cone shape, strength of the speaker diaphragm 1 is further increased. The size of the speaker diaphragm 1 can be set in accordance with a speaker to be used. The speaker diaphragm may be for a small speaker provided in, for example, headphones, earphones, mobile electronic devices, and the like.

### <Substrate>

The speaker diaphragm 1 includes a substrate la having a resin matrix 2 and fibers 3 dispersed in the resin matrix 2. The substrate 1a can be formed by injection molding described later. The substrate 1a may have a pair of skin layers forming surface layers on the front surface side and the back surface side thereof, and a core layer formed between the pair of skin layers. That is, the core layer may be interposed between the pair of skin layers. The pair of skin layers are layers formed from the resin matrix 2 and the fibers 3 in a surface layer portion, which have come into contact with a mold cavity and flowed during injection molding. The core layer is a layer formed from the resin matrix 2 and the fibers 3 which have been relatively slowly cooled and solidified without coming into contact with the mold cavity. In the speaker diaphragm 1, the fiber 3 may have different orientation directions in the skin layers and the core layer.

The substrate 1a of the speaker diaphragm 1 (in the present embodiment, the speaker diaphragm 1 itself) has a substantially uniform thickness. The lower limit of an average thickness T of the substrate 1a of the speaker diaphragm 1 is preferably 100 μm, more preferably 300 μm. On the other hand, the upper limit of the average thickness T of the substrate 1a of the speaker diaphragm 1 is preferably 800 μm, more preferably 650 μm. If the average thickness T is less than the lower limit, the speaker diaphragm 1 may have insufficient rigidity, or the speaker diaphragm 1 may be difficult to form by injection molding. On the contrary, if the average thickness T exceeds the upper limit, the speaker diaphragm 1 may be unnecessarily heavy. The term “substantially uniform thickness” means that the ratio of the maximum thickness to the minimum thickness is 1 or more and 1.20 or less. The “average thickness” means an average value of thicknesses at arbitrary 10 points. It should be noted that the ratios described for the above “substantially uniform thickness” are for the speaker diaphragm having a substantially uniform thickness, and are not applied to the speaker diaphragm intentionally provided with ribs and the like.

(Resin Matrix)

As described above, the resin matrix 2 contains a thermoplastic resin as a main component. Examples of the thermoplastic resin include polyethylene, polypropylene, polystyrene, fluororesin, polycarbonate, polysulfone, polyether sulfone, polyethylene terephthalate, polybutylene terephthalate, polyamide, polyimide, acrylonitrile-butadiene-styrene resin, and the like. They may be used alone or in combination of two or more. Among them, polypropylene is preferable as the thermoplastic resin. When the thermoplastic resin is polypropylene, a vibration damping rate (internal loss) of the speaker diaphragm 1 at an audible frequency can be increased. Further, when the thermoplastic resin is polypropylene, it becomes easy to disperse the fibers 3 in a non-bonded state with the resin matrix 2 as described later, thereby further increasing the vibration damping rate and improving sound reproducibility. The fibers 3 and the resin matrix 2 do not have to be bonded at least partially, and the entire surface of the fibers 3 may not be bonded to the resin matrix 2.

### (Fiber)

The fibers 3 are polyparaphenylenebenzobisoxazol fibers. When the fibers 3 of the speaker diaphragm 1 are the polyparaphenylenebenzobisoxazol fibers, it is possible to increase the rigidity while suppressing a decrease in the vibration damping rate.

The lower limit of the content of the fibers 3 in the substrate 1a (in other words, the content of the fibers 3 in the speaker diaphragm 1) is preferably 3% by mass, more preferably 6% by mass. On the other hand, the upper limit of the content of the fibers 3 in the substrate 1a is preferably 30% by mass, more preferably 22% by mass, even more preferably 15% by mass. If the content of the fibers 3 is less than the lower limit, the speaker diaphragm 1 may have insufficient rigidity. On the contrary, if the content of the fibers 3 exceeds the upper limit, the fibers 3 may be entangled with each other in the resin matrix 2, and the uniform dispersibility of the fibers 3 in the resin matrix 2 may become insufficient. Further, when the content of the fibers 3 exceeds the upper limit, when the resin composition containing the resin 3 and the thermoplastic resin is heated and made to pass through a nozzle or the like of an injection molding device, the fibers 3 are likely to be clogged due to uneven distribution, which may make it difficult to produce the speaker diaphragm 1.

The lower limit of the average length of the fibers 3 is 0.5 mm, preferably 1.0 mm. On the other hand, the upper limit of the average length of the fibers 3 is 3.0 mm, preferably 2.5 mm, more preferably 1.5 mm. If the average length of the fibers 3 is less than the lower limit, the effect of improving the rigidity by the fibers 3 may be insufficient. On the contrary, when the average length of the fibers 3 exceeds the upper limit, the fibers 3 are likely to be entangled with each other, and the uniform dispersibility of the fibers 3 in the resin matrix 2 may be insufficient. The lengths of the fibers 3 dispersed in the resin matrix 2 may be non-uniform as long as the average length is within the above range.

The upper limit of the maximum length of the fibers 3 dispersed in the resin matrix 2 is preferably 5.0 mm, more preferably 4.0 mm, even more preferably 3.0 mm. As described above, by setting the maximum length of the fibers 3 to equal to or less than the upper limit, it is easy to surely prevent the fibers 3 from being entangled with each other.

The lower limit of an average aspect ratio of the fibers 3 is preferably 20, more preferably 50. On the other hand, the upper limit of the average aspect ratio of the fibers 3 is preferably 300, more preferably 200. If the average aspect ratio is less than the lower limit, it may be difficult to control the orientation direction of the fibers 3. On the contrary, when the average aspect ratio exceeds the upper limit, the fibers 3 may be easily entangled with each other. The “average aspect ratio of fibers” refers to a value obtained by averaging the ratios of lengths to diameters of 10 fibers arbitrarily extracted.

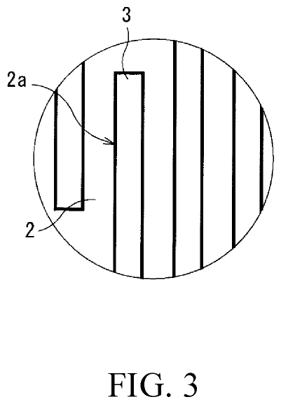

As illustrated in FIG. 3, preferably, the resin matrix 2 and the fibers 3 are not bonded at least partially. In other words, preferably, the fibers 3 are embedded in a hollow portion 2a of the resin matrix 2 in a non-bonded state with the resin matrix 2, that is, in a state where the fibers 3 are in close contact with the resin matrix 2. At this time, it is sufficient that the fibers 3 and the resin matrix 2 are not bonded at least partially. As a result, the speaker diaphragm 1 can increase the vibration damping rate. In the speaker diaphragm 1, the shape of the hollow portion 2a is preferably the same as the shape of the fibers 3 embedded in the hollow portion 2a from the viewpoint of increasing the rigidity by the fibers 3. In other words, preferably, there is no gap between the resin matrix 2 and the fibers 3. It should be noted that when the fibers 3 and the above-mentioned thermoplastic resin are incompatible and both are not chemically bonded, the speaker diaphragm 1 can hold the fibers 3 in a non-bonded state with the resin matrix 2. Further, even if the fibers 3 and the thermoplastic resin are not chemically bonded, the speaker diaphragm 1 can uniformly disperse the fibers 3 in the matrix 2, by controlling the content and the average length of the fibers 3 within the above range.

### (Other Components)

The substrate 1a of the speaker diaphragm 1 may contain components other than the resin matrix 2 and the fibers 3 as long as the effects of the present invention are not impaired. Examples of other components include a colorant such as titanium oxide, an ultraviolet absorber, and a compatibilizing agent.

### <Advantage>

The fibers 3 dispersed in the resin matrix 2 of the substrate 1a of the speaker diaphragm 1 are polyparaphenylenebenzobisoxazol fibers, and thus the fibers 3 can easily increase the rigidity sufficiently. Particularly, in the speaker diaphragm 1, an average length of the polyparaphenylenebenzobisoxazol fibers is within the above range, and thus, for example, by controlling the content of the fibers 3 within the above range, the fibers 3 can be uniformly dispersed in the resin matrix 2. As a result, the speaker diaphragm 1 can uniformly increase the rigidity over the entire region.

### [Method for Producing a Speaker Diaphragm]

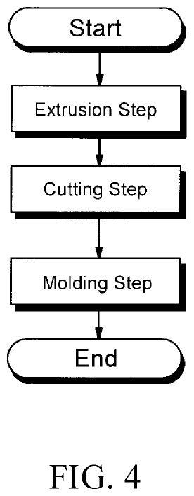

Next, a method for producing the speaker diaphragm 1 of FIG. 1 will be described with reference to FIG. 4. The method for producing the speaker diaphragm includes a step (extrusion step) of extruding a resin composition containing a thermoplastic resin and fibers 3 into a rod shape, a step (cutting step) of cutting the extruded body extruded in the extrusion step into pellets, and a step (molding step) of injection-molding the pellet obtained in the cutting step.

### (Extrusion Step)

The extrusion step extrudes the resin composition into a rod shape, while kneading a resin composition containing a thermoplastic resin and fibers 3. The extrusion step can be performed using an extrusion molding device. This extrusion molding device includes: for example, an extruder for kneading the resin composition, which has a cylinder for guiding the resin composition and a screw mounted in the cylinder; a T-die for letting the resin composition kneaded by the extruder flow out in a rod shape; and a cooling unit for cooling the resin composition extruded from the T-die. The extrusion step extrudes the resin composition into a rod shape and then cools it in the cooling unit to solidify the resin composition in the shape at the time of extrusion. As a result, a rod-shaped extruded body is obtained.

Examples of the thermoplastic resin used in the extrusion step include the above-mentioned thermoplastic resin contained as the main component of the resin matrix 2 of the substrate 1a of the speaker diaphragm 1 of FIG. 1. Of these, polypropylene is preferable as the thermoplastic resin.

The fibers 3 used in the extrusion step are polyparaphenylenebenzobisoxazol fibers. The length of each of the polyparaphenylenebenzobisoxazol fibers is not particularly limited, but can be, for example, 1 mm or more and 10 mm or less, preferably 3 mm or more and 6 mm or less. The method for producing the speaker diaphragm can adjust the length of each of the fibers 3 contained in the substrate 1a of the speaker diaphragm 1 obtained by adjusting the length of a pellet in the cutting step described later within the above range.

The lower limit of the content of the fibers 3 in the resin composition is preferably 3% by mass, more preferably 6% by mass. On the other hand, the upper limit of the content of the fibers 3 is preferably 30% by mass, more preferably 22% by mass, even more preferably 15% by mass. If the content of the fibers 3 is less than the lower limit, the rigidity of the obtained speaker diaphragm 1 may be insufficient. On the contrary, when the content of the fibers 3 exceeds the upper limit, the uniform dispersibility of the fibers 3 in the resin matrix 2 may be insufficient.

The resin composition may contain, as other components, a colorant such as titanium oxide, an ultraviolet absorber, a compatibilizing agent for compatibilizing the thermoplastic resin and the fibers 3, and the like.

### (Cutting Step)

The cutting step cuts the extruded body extruded in the extrusion step at equal intervals in the longitudinal direction to form a plurality of columnar pellets. Since the fibers 3 contained in the extruded body are easily oriented in the extruding direction, the average length of the fibers 3 can be suppressed to be equal to or less than the length of the pellet by cutting the extruded body at equal intervals. In the cutting step, by dividing the polyparaphenylenebenzobisoxazole fibers each having a length within the above range into two or more in the longitudinal direction at the same time as forming of the pellets, it is easy to non-uniformly adjust the length of each of the fibers 3 contained in the substrate 1a of the obtained speaker diaphragm 1. The cutting step cuts, for example, the extruded body at intervals of 3 mm or less to form a plurality of columnar pellets each having a length of 3 mm or less.

The lower limit of the average length of the fibers 3 after the cutting step is 0.5 mm, preferably 1.0 mm. On the other hand, the upper limit of the average length of the fibers 3 after the cutting step is 3.0 mm, preferably 2.5 mm, more preferably 1.5 mm. If the average length of the fibers 3 is less than the lower limit, the rigidity of the obtained speaker diaphragm 1 may not be sufficiently increased. On the other hand, when the average length of the fibers 3 exceeds the upper limit, the fibers 3 are easily entangled with each other in the substrate 1a of the obtained speaker diaphragm 1, and the uniform dispersibility of the fibers 3 in the resin matrix 2 may be insufficient.

### (Molding Step)

The molding step forms the substrate 1a of the speaker diaphragm 1 by injection-molding the pellet obtained in the cutting step. The molding step can be performed using an injection molding device. This injection molding device includes, for example, a cylinder having a nozzle at its tip, a hopper which is connected to the cylinder and into which the pellets obtained in the cutting step are charged, a screw mounted in the cylinder, and a mold in which a cavity communicating with an opening of the nozzle is formed. The cavity has an inverted shape of the substrate 1a of the speaker diaphragm 1. In the cavity, a portion corresponding to a bottom portion (center portion when viewed in the axial direction) of the substrate 1a of the speaker diaphragm 1 communicates with the opening of the nozzle. The molding step radially fills the cavity with a resin composition (melt of the pellets) from the portion corresponding to the bottom portion. Further, the molding step cools the cavity after filling of the resin composition to cure the resin composition. This molded product obtained by curing the resin composition is configured as the substrate 1a of the speaker diaphragm 1.

The lower limit of the temperature inside the cavity in the molding step is preferably 30° C. On the other hand, the upper limit of the temperature inside the cavity is preferably 50° C. If the temperature inside the cavity is less than the lower limit, fluidity of the resin in the cavity may be insufficient, and it may be difficult to control the orientation direction of the fibers 3. On the contrary, if the temperature inside the cavity exceeds the upper limit, it may be difficult to sufficiently cool the resin composition after the cavity being filled, and it may be difficult to take out the obtained substrate 1a of the speaker diaphragm from inside the cavity.

The lower limit of an injection speed of the resin composition in the molding step is preferably 80 mm/s, more preferably 100 mm/s. On the other hand, the upper limit of the injection speed is preferably 200 mm/s, more preferably 150 mm/s. If the injection speed is less than the lower limit, the fluidity of the resin composition in the cavity becomes insufficient, which may make it difficult to control the orientation direction of the fibers 3 in the cavity. On the contrary, when the injection speed exceeds the upper limit, the fluidity of the resin composition in the cavity becomes too large, which may make it difficult to control the orientation direction of the fibers 3 in the cavity.

### <Advantage>

The method for producing the speaker diaphragm injection-molds the substrate 1a of the speaker diaphragm using pellets obtained by cutting a rod-shaped extruded body containing a thermoplastic resin and polyparaphenylenebenzobisoxazole fibers, so that it is possible to produce a speaker diaphragm in which the polyparaphenylenebenzobisoxazole fibers are sufficiently and uniformly dispersed in the thermoplastic resin. Particularly, since the average length of the polyparaphenylenebenzobisoxazole fibers in the pellet is within the above range, the method for producing a speaker diaphragm can uniformly disperse the fibers without being entangled in the thermoplastic resin in the obtained substrate 1a of the speaker diaphragm, for example, by controlling the content of the polyparaphenylenebenzobisoxazole fibers in the resin composition within the above range. As a result, the method for producing a speaker diaphragm can produce the speaker diaphragm 1 whose rigidity is uniformly increased over the entire region.

### Other Embodiments

The above embodiment does not limit the configuration of the present invention. Therefore, in the above-described embodiment, it is possible to omit, replace, or add the constituent elements of each part of the embodiment based on the description of the present specification and a technical common sense, and all of them should be construed as belonging to the scope of the present invention.

For example, the speaker diaphragm does not necessarily have a cone shape, and may have a flat plate shape, for example.

### EXAMPLE

Hereinafter, the present invention will be described in detail based on examples, but the present invention is not limitedly interpreted based on the description of the examples.

### [No. 1]

A resin composition containing polypropylene (manufactured by Nippon Pigment Co., Ltd.) as a thermoplastic resin, and polyparaphenylenebenzobisoxazole fibers (“Zylon” (registered trademark) manufactured by Toyobo Co., Ltd.) each having a fiber length of 6 mm was extruded into a rod shape while being kneaded in a uniaxial extruder. Further, the extruded resin composition was cooled and solidified in the shape at the time of extrusion (extrusion step). The content of polypropylene in this resin composition was 94% by mass, and the content of polyparaphenylenebenzobisoxazole fibers was 6% by mass. The extrusion conditions were a discharge rate of 3 kg/h, a screw rotation speed of 17 rpm, and an extrusion temperature of 165° C. to 185° C.

The extruded body extruded in the extrusion step was cut into pellets each having a length of 3 mm (cutting step). Further, the columnar pellets obtained by the cutting in the cutting step were injection-molded using an injection molding device to obtain a No. 1 speaker diaphragm (substrate single body). This injection molding device has a cylinder having a nozzle at its tip, a hopper which is connected to the cylinder and into which the pellets obtained in the cutting step are charged, a screw mounted in the cylinder, and a mold in which a cavity communicating with an opening of the nozzle is formed. Further, the cavity has a cone-shaped internal space, and the opening of the nozzle communicates with the bottom portion of this internal space. The injection molding conditions were a cylinder temperature of 200° C. to 210° C., a mold temperature of 40° C., an injection speed of 100 mm/s, an injection pressure of 50 MPa, and a back pressure of 2 MPa.

### (Fiber Shape)

The average length and the like of the polyparaphenylenebenzobisoxazole fibers in the No. 1 speaker diaphragm were measured by the following procedure.

First, the No. 1 speaker diaphragm was heated in a muffle furnace at 450° C. for 4 hours to melt the thermoplastic resin (polypropylene) and take out the polyparaphenylenebenzobisoxazole fibers from the speaker diaphragm. After cooling the speaker diaphragm after heating for 10 hours, the polyparaphenylenebenzobisoxazole fibers were dispersed in water, and a fiber tester manufactured by Lorentzen & Wettre was used to measure lengths of any 10 fibers. The average fiber length was calculated by averaging the measured values to be 1.35 mm. The maximum value (maximum fiber length) of the measured values was 3.2 mm. Furthermore, when the average diameter and the average straightness rate of the polyparaphenylenebenzobisoxazole fibers were calculated by the same procedure, the average diameter was 17.4 μm (aspect ratio 77.6) and the average straightness rate was 90%. The “average straightness rate of fibers” means a value calculated by the average distance between ends of fibers/the average fiber length×100.

### [No. 2]

Using Zylon having a fiber length of 3 mm as the polyparaphenylenebenzobisoxazole fiber, a speaker diaphragm (single substrate) was produced under the same conditions as in No. 1 except that the content of polypropylene was 90% by mass, and the content of the polyparaphenylenebenzobisoxazole fibers was 10% by mass in the resin composition.

For a No. 2 speaker diaphragm, the average length, maximum length, average diameter, and average straightness rate of the polyparaphenylenebenzobisoxazole fibers were calculated in the same procedure as in No. 1, and the average length was 0.97 mm, the maximum length was 1.6 mm, the average width was 17.9 μm (aspect ratio 54.2), and the average straightness rate was 85.5%.

### [No. 3]

Using Zylon having a fiber length of 1 mm as the polyparaphenylenebenzobisoxazole fiber, a speaker diaphragm (single substrate) was produced under the same conditions as in No. 1 except that the content of polypropylene was 85% by mass, and the content of the polyparaphenylenebenzobisoxazole fiber was 15% by mass in the resin composition.

### [No. 4]

Using Zylon having a fiber length of 3 mm as the polyparaphenylenebenzobisoxazole fiber, a speaker diaphragm (single substrate) was produced under the same conditions as in No. 1 except that the content of polypropylene was 78.6% by mass, and the content of the polyparaphenylenebenzobisoxazole fibers was 21.4% by mass in the resin composition. The average length, average diameter, and average straightness rate of the polyparaphenylenebenzobisoxazole fibers in a No. 4 speaker diaphragm were the same as those of No. 2.

### [No. 5]

Using Zylon having a fiber length of 1 mm as the polyparaphenylenebenzobisoxazole fiber, a speaker diaphragm (single substrate) was produced under the same conditions as in No. 1 except that the content of polypropylene was 90% by mass, and the content of the polyparaphenylenebenzobisoxazole fibers was 10% by mass in the resin composition.

### [No. 6]

A speaker diaphragm (single substrate) was produced under the same conditions as in No. 1 except that the content of polypropylene was 90% by mass, and the content of the polyparaphenylenebenzobisoxazole fibers was 10% by mass in the resin composition. The average length, average diameter, and average straightness rate of the polyparaphenylenebenzobisoxazole fibers in a No. 6 speaker diaphragm were the same as those of No. 1.

### [No. 7]

Using Zylon having a fiber length of 1 mm as the polyparaphenylenebenzobisoxazole fiber, a speaker diaphragm (single substrate) was produced under the same conditions as in No. 1 except that the content of polypropylene was 80% by mass, and the content of the polyparaphenylenebenzobisoxazole fibers was 20% by mass in the resin composition.

### [No. 8]

Using Zylon having a fiber length of 1 mm as the polyparaphenylenebenzobisoxazole fiber, a speaker diaphragm (single substrate) was produced under the same conditions as in No. 1 except that the content of polypropylene was 70% by mass, and the content of the polyparaphenylenebenzobisoxazole fibers was 30% by mass in the resin composition.

### (Storage Elastic Modulus)

Storage elastic moduli [GPa] at 250 Hz and 1000 Hz were measured for the No. 2 and No. 5 to No. 8 speaker diaphragms. The storage elastic moduli were each measured in a tension mode at the temperature of 23±2° C. by cutting a rectangular sample with a width of 5 mm, a length of 40 mm, and a thickness of 0.5 mm, and using a dynamic viscoelasticity measuring device (“DMA+150”) manufactured by Metravib Co., Ltd. The results of this measurement are shown in Table 1.

### (Loss Elastic Modulus)

Loss elastic moduli [GPa] at 250 Hz and 1000 Hz were measured for the No. 2 and No. 5 to No. 8 speaker diaphragms. The loss elastic moduli were each measured under the same measurement conditions as the storage elastic modulus using the same sample and measuring device as the storage elastic modulus. The results of this measurement are shown in Table 1.

### (Internal Loss)

For the No. 2 and No. 5 to No. 8 speaker diaphragms, the internal losses (tan6) at 250 Hz and 1000 Hz were measured. The internal losses were each measured under the same measurement conditions as the storage elastic modulus using the same sample and measuring device as the storage elastic modulus. The results of this measurement are shown in Table 1.

### (Fiber Bonded State)

In the No. 1 to No. 8 speaker diaphragms, some of the polyparaphenylenebenzobisoxazole fibers can be pulled out from the resin matrix, and the resin matrix and the polyparaphenylenebenzobisoxazole fibers were not bonded at least partially.

TABLE 1

| | 250 Hz | | | 1000 Hz | | |
|---|---|---|---|---|---|---|
| | storage | loss | | storage | loss | |
| | elastic | elastic | internal | elastic | elastic | internal |
| | modulus | modulus | loss | modulus | modulus | loss |
| | [GPa] | [GPa] | (tanδ) | [GPa] | [GPa] | (tanδ) |
| No. 2 | 2.39 | 0.204 | 0.085 | 3.20 | 0.317 | 0.099 |
| No. 5 | 2.45 | 0.206 | 0.084 | 3.37 | 0.323 | 0.096 |
| No. 6 | 2.55 | 0.202 | 0.079 | 3.40 | 0.310 | 0.091 |
| No. 7 | 3.05 | 0.227 | 0.074 | 4.03 | 0.350 | 0.087 |
| No. 8 | 3.59 | 0.243 | 0.068 | 4.74 | 0.372 | 0.078 |

### [Evaluation Results]

The average lengths of the polyparaphenylenebenzobisoxazole fibers in the No. 1 to No. 8 speaker diaphragms were all 0.5 mm or more and 3.0 mm or less. When the No. 1 to No. 8 speaker diaphragms were visually confirmed, in all cases, polyparaphenylenebenzobisoxazole fibers were uniformly dispersed in the resin matrix made of polypropylene. From this, it can be seen that the No. 1 to No. 8 speaker diaphragms have uniformly increased rigidity over the entire region. In addition to polypropylene and polyparaphenylenebenzobisoxazole fibers, the resin composition may contain titanium oxide as a colorant and/or a compatibilizing agent.

As shown in Table 1, comparing No. 2, No. 5, and No. 6 in which the content of the polyparaphenylenebenzobisoxazole fibers in the speaker diaphragm was 10% by mass, it can be seen that the storage elastic modulus and the loss elastic modulus are kept substantially constant, regardless of change in the average length of the polyparaphenylenebenzobisoxazole fibers. Further, comparing No. 2, No. 5, and No. 6, it can be seen that when the average length of the polyparaphenylenebenzobisoxazole fibers is 1.35 mm (No. 6) or more, the internal loss tends to decrease. On the contrary, it can be seen that when the average length of the polyparaphenylenebenzobisoxazole fibers is 0.97 mm or less (No. 2 and No. 5), even if the average length of the polyparaphenylenebenzobisoxazole fibers becomes long, the internal loss is kept equal.

Further, as shown in Table 1, comparing No. 5, Mo. 7, and No. 8 in which the average length of the polyparaphenylenebenzobisoxazole fibers was the same, and the content of the polyparaphenylenebenzobisoxazole fibers was changed, it can be seen that the storage elastic modulus and the loss elastic modulus increase substantially in proportion to the increase in the content of the polyparaphenylenebenzobisoxazole fibers, while the reduction of the internal loss caused by the increase in the content of the polyparaphenylenebenzobisoxazole fibers is suppressed relatively small.

### INDUSTRIAL APPLICABILITY

As described above, a speaker diaphragm according to the embodiments of the present invention can be uniformly increased in rigidity over the entire region, and thus is suitably used as a rigid and relatively inexpensive diaphragm.

### REFERENCE SIGNS LIST

speaker diaphragm

1a substrate

2 resin matrix

2a hollow portion

3 fiber

1. A speaker diaphragm comprising:
a substrate having:
a resin matrix containing a thermoplastic resin as a main component; and
fibers dispersed in the resin matrix, wherein
the fibers are polyparaphenylenebenzobisoxazol fibers, and
an average length of the fibers is 0.5 mm or more and 3.0 mm or less.

2. The speaker diaphragm according to claim 1, wherein the speaker diaphragm has a cone shape.

3. The speaker diaphragm according to claim 2, wherein the substrate has:
a pair of skin layers forming surface layers on a front surface side and a back surface side of the substrate, and
a core layer formed between the pair of skin layers.

4. The speaker diaphragm according to claim 3, wherein a content of the fibers in the substrate is 3% by mass or more and 30% by mass or less.

5. The speaker diaphragm according to claim 4, wherein the resin fibers are at least partially in an unbonded state with the resin matrix.

6. The speaker diaphragm according to claim 5, wherein the thermoplastic resin is polypropylene.

7. A method for producing a speaker diaphragm, comprising the steps of:
extruding a resin composition containing a thermoplastic resin and fibers into a rod shape;
cutting the rod shape into pellets; and
injection-molding the pellets, wherein
the fibers are polyparaphenylenebenzobisoxazol fibers, and
an average length of the fibers after the cutting step is 0.5 mm or more and 3.0 mm or less.
